(19) United States
(12) Patent Application Publication
(10) Pub. No.: US 2007/0103384 A1
(43) Pub. Date: May 10, 2007

(54) Liquid crystal information display

(75) Inventors: Chin-Feng Hsieh, Taichung County (TW); Yan-Chu Lin, Changhua County (TW)

Correspondence Address: BIRCH STEWART KOLASCH & BIRCH, PO BOX 747, FALLS CHURCH, VA, 22040-0747, US

(73) Assignee: UNITED RADIANT TECHNOLOGY CORP.

(21) Appl. No.: 11/269,688

(22) Filed: Nov. 9, 2005

(51) Int. Cl. G09G 5/00

(52) U.S. Cl. 345/1.1

(57) ABSTRACT

The present invention discloses a liquid crystal information display, which comprises a main-control system used to edit the information to be displayed, a transmission interface transmitting the edited information, at least one liquid crystal display (LCD) billboard displaying the edited information, and at least one control system, receiving and storing the edited information, and controlling the operation of the LCD billboard. The LCD billboard is formed of at least one LCD panel and at least one driver circuit board. Via concatenation flat cables, multiple LCD panels can be concatenated to form the desired configuration of the LCD billboard. A single control system can control a single LCD billboard or a group of LCD billboards. Otherwise, a single control system can also respectively control multiple groups of LCD billboards.

### FIELD OF THE INVENTION

The present invention relates to a liquid crystal information display, particularly to an information system formed of liquid crystal display (LCD) panels

### BACKGROUND OF THE INVENTION

LED (light emitting diode) has unique characteristics of high brightness, high reliability and high dimensional adaptability. The outstanding application thereof is the spectacular dynamic billboard. The electronic billboard is an important application among various applications of LED, and it is often an indoor single-unit system or an interconnected multi-unit system. LED billboards are usually seen in medical centers, production lines, airports, and bus/railway stations, and a large-scale LED billboard is often used as an outdoor spectacular advertisement. For an intelligent traffic system, instant information broadcast is an important service; thus, the LED display device plays a leading role in bus/railway stations, seaports/airports, freeways, city roads, and parking areas in instant information service.

There are two LED display modes. One is that the display contents are edited in the input device having a system program, and then the data is transmitted via a wired or a wireless communication interface to the display module. The other is that the display module is integrated with the control center, and under the system operation, the data is transmitted via a wired or a wireless communication interface and received by the display module, and then, the display module broadcasts the information instantly; it is usually used in a traffic schedule or a production line.

However, being a display unit (pixel), LED has the drawback of low resolution. When the LED display is watched closely, discrete LED elements are seen clearly, which makes the resolution of characters and pictures become inferior; thus, display quality is seriously influenced. To obtain a better resolution, LED of smaller packaging size is adopted as the unitary light-emitting element; however, it brings about the problems of high material consumption, high power consumption and high product price.

Besides, owing to LED characteristics and the cost consideration, the LED billboard system is usually monochromatic. A monochromatic LED billboard can only present red character/black background, green character/black background, or orange character/black background; thus, the color performance thereof is somewhat monotonous. If the user adopts a chromatic system alternatively, there are still the problems of low resolution and high price.

Further, through a given interval of service, LED brightness decays, and the decay extent of those LED's will be different. Thus, the brightness of the entire screen will be uneven. For a dynamically displayed image, the characters and pictures will seem waving or floating owing to the persistence of vision.

### SUMMARY OF THE INVENTION

The primary objective of the present invention is to provide a liquid crystal display (LCD) module to overcome the problems of dazzling, low resolution, and low design flexibility of resolution of the conventional LED electronic billboard.

Another objective of the present invention is to provide a liquid crystal information display to overcome the problems of high power consumption, monotonous color performance, and uneven brightness/waving and floating image resulting from variation in the decay extent of LED brightness.

Further another objective of the present invention is to provide a liquid crystal information display, wherein the modularized LCD units can be assembled into low-cost and diversified LCD billboards to meet the users' demands.

The present invention proposes a liquid crystal information display, comprising a main-control system having a billboard-operating software, and being used to edit a series or multiple rows of information to be displayed and the display manner of the information, a transmission interface transmitting the edited information via the format of a standard TCP (transmission control protocol) interface.

At least one LCD billboard displays the information edited by the main-control system, and at least one control system receives and stores the information transmitted from the transmission interface, and controlling the operation of the LCD billboard. Each LCD billboard is formed of at least one LCD panel and at least one driver circuit board. Via concatenation flat cables, multiple LCD panels can be concatenated to form the desired configuration of the LCD billboard. In practical applications, a single control system can control a single LCD billboard or a group of LCD billboard. Otherwise, a single control system can also respectively control multiple groups of LCD billboard; thus, the broadcasting area of the liquid crystal information display can be enlarged.

### BRIEF DESCRIPTION OF THE DRAWINGS

FIG. 1 is a schematic diagram showing the liquid crystal information display according to the present invention.

FIG. 2 is another schematic diagram showing the liquid crystal information display according to the present invention.

FIG. 3 is a block diagram showing the control system according to the present invention.

FIG. 4 is a schematic diagram showing the structure of the LCD billboard according to the present invention.

FIG. 5 is a first schematic diagram showing the display unit according to the present invention.

FIG. 6 is a second schematic diagram showing the display unit according to the present invention.

FIG. 7 is a third schematic diagram showing the display unit according to the present invention.

FIG. 8 is a fourth schematic diagram showing the display unit according to the present invention.

FIG. 9 is a fifth schematic diagram showing the display unit according to the present invention.

FIG. 10 is a schematic diagram showing one embodiment of the present invention.

FIG. 11 is a schematic diagram showing another embodiment of the present invention.

FIG. 12 is a schematic diagram showing the structure of the LCD billboard as shown in FIG. 11.

### DETAILED DESCRIPTION OF THE PREFERRED EMBODIMENTS

The technical contents of the present invention are to be stated below in cooperation with the attached drawings.

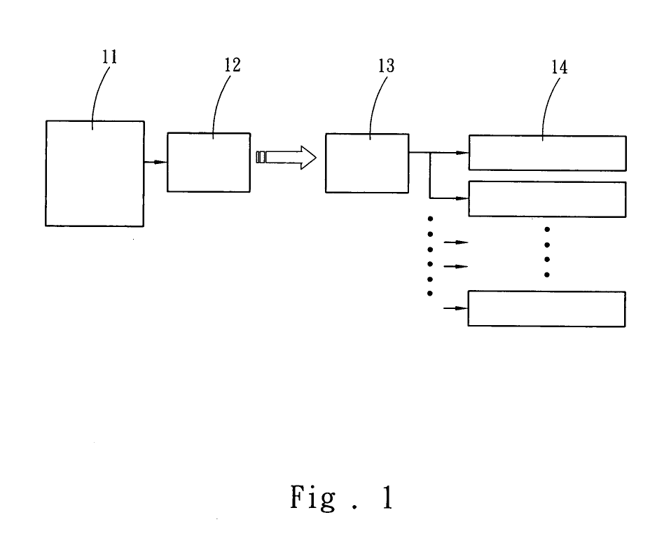

Refer to FIG. 1 a schematic diagram showing the liquid crystal information display according to the present invention. The liquid crystal information display of the present invention comprises a main-control system 11, a transmission interface 12, at least one control system 13, and at least one LCD billboard 14.

The main-control system 11 has a liquid crystal information display operating software and is used to edit a series or multiple lows of information to be displayed and the display manner of the information. The operating software transforms the input contents into the format of a predetermined standard transmission control protocol. The main-control system 11 may be a personal computer, a notebook computer, a palm-size computer, a personal digital assistant, or a mobile phone, which has the operating software to edit the contents to be displayed in the liquid crystal information display. The user edits the contents to be displayed and the display manner via directly inputting that into the window interface of the operating software.

The transmission interface 12 transmits the edited information via the format of a standard TCP (transmission control protocol) interface. The transmission interface 12 may be a wired TCP interface or a wireless TCP interface. The wired TCP interface may be a standard serial interface RS232/RS485, a serial port RJ45, a USB (universal serial bus), or a wired network. The wireless TCP interface may be a RF (Radio Frequency) interface, a GPRS (General Packet Radio Service) interface, a Bluetooth interface, or a wireless network.

The control system 13 receives and stores the information transmitted from the transmission interface 12, controls the LCD billboard 14 and drives the LCD billboard 14 to display the information.

The LCD billboard 14 displays the information edited by the main-control system 11.

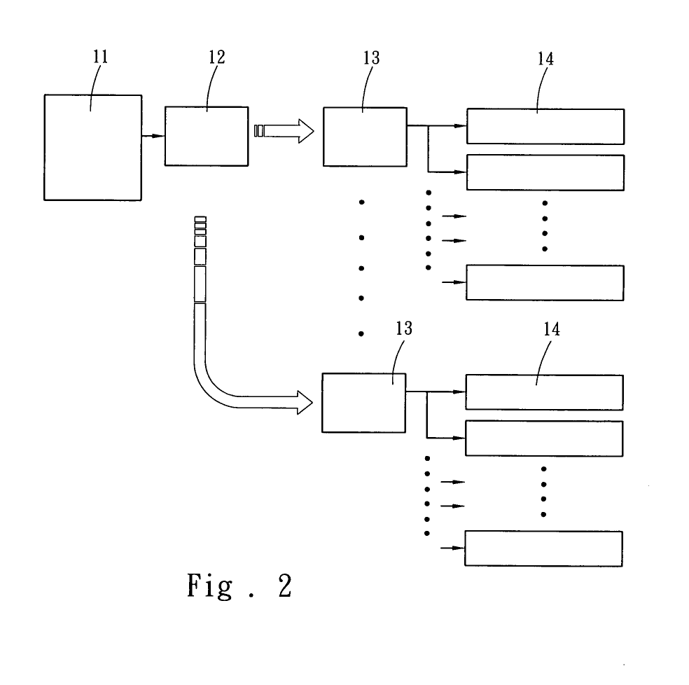

In practical applications, a single control system 13 can control a single LCD billboard 14 or a group of LCD billboards 14, as shown in FIG. 1. Otherwise, as shown in FIG. 2, a single control system 13 can also respectively control multiple groups of LCD billboard 14; thus, the broadcasting area of the liquid crystal information display can be enlarged.

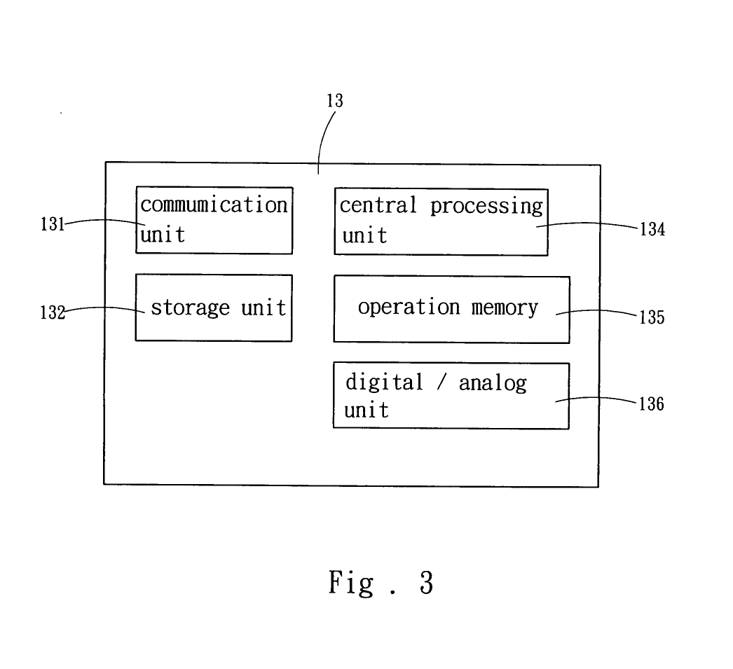

Refer to FIG. 3 a block diagram of the control system according to the present invention. The control system 13 comprises a communication unit 131, a storage unit 132, a central processing unit 134, an operation memory unit 135 and a digit/analog converter unit 136.

The communication unit 131 receives the data transmitted from the transmission interface 12. The TCP interface of the communication unit 131 collaborates with the transmission interface 12 and may be a wired TCP interface or a wireless TCP interface. The wired TCP interface may be a standard serial interface RS232/RS485, a serial port RJ45, a USB (universal serial bus), or a wired network. The wireless TCP interface may be a RF (Radio Frequency) interface, a GPRS (General Packet Radio Service) interface, a Bluetooth interface, or a wireless network.

The storage unit 132 stores the data received by the communication unit 131. The central processing unit 134 processes the data stored in the storage unit 132, executes instructions, and coordinates all those units. The operation memory unit 135 temporarily stores the data or programs processed by the central processing unit 134. The digit/analog converter unit 136 controls the voltage signals needed by the LCD billboard 14.

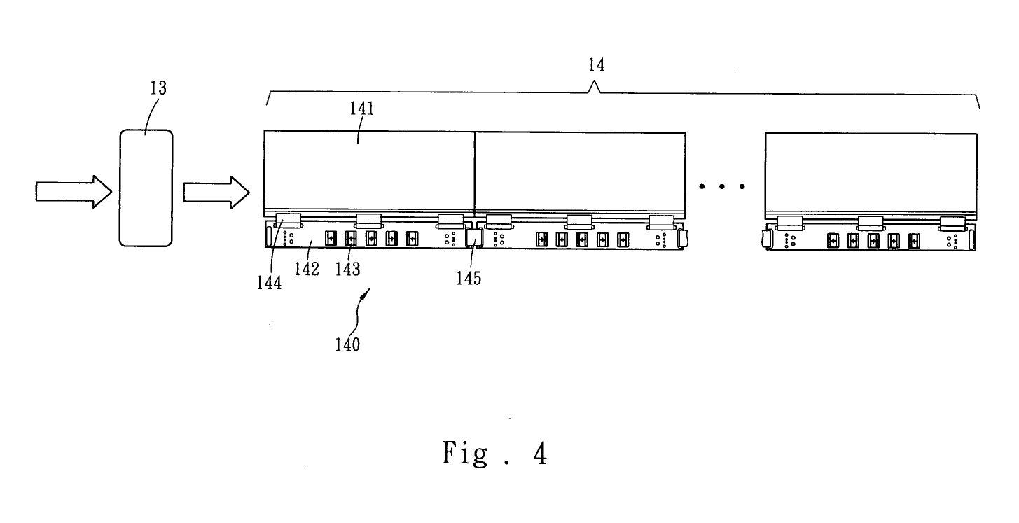

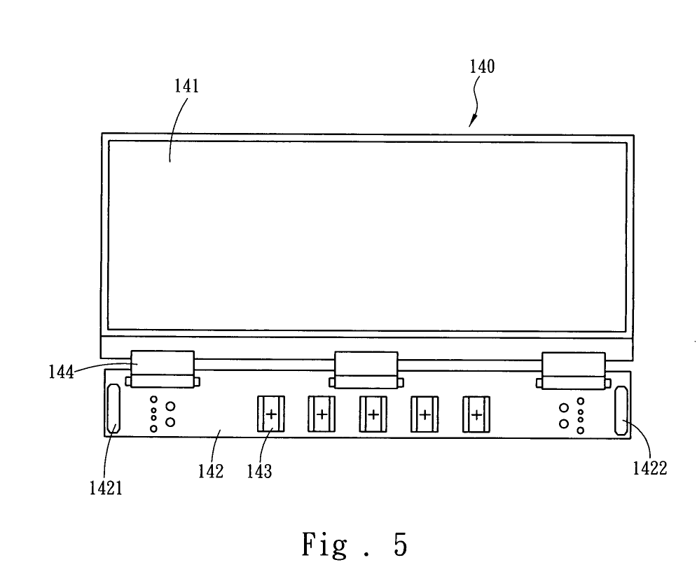

Refer to FIG. 4 a schematic diagram showing the structure of the LCD billboard 14 according to the present invention. Each LCD billboard 14 comprises at least one display unit 140. As shown in FIG. 5, the display unit 140 further comprises a LCD panel 141 and a control circuit system 142. The control circuit system 142 further comprises multiple driver elements 143, and those driver elements 143 control/drive the LCD panel 141 via multiple flat cables 144. The LCD panel 141 may be a monochromatic or a chromatic one of the group of the transmission type, reflective type and transflective type LCD display panels. The substrate of the control circuit system 142 may be a PCB (printed circuit board) or an FPC (flexible printed circuit).

In the design of the LCD panel 141, the dot, the gap and the shape of the dot can be arbitrarily designed according to various demands. The size of the dot can range from less than 0.2 mm to nearly as large as the electrically-conductive glass substrate, and the shape of the dot is arbitrary. Contrarily, in the conventional LED electronic billboard, the dot, the gap and the shape of the dot of LED are all standardized and without any flexibility. Besides, the light source of the LCD panel 141 is planar and evenly distributed. Contrarily, in the conventional LED electronic billboard, as LED is a point light source, the brightness is almost concentrated at the light-emitting point, which makes the image seem granular. Therefore, the resolution, softness, and visual effect of the LCD panel 141 are all superior to those of the conventional LED electronic billboard. Thus, the present invention can overcome the problems of dazzling, low resolution, and low design flexibility of resolution of the conventional LED electronic billboard. Further, the present invention can also overcome the problems of high power consumption, monotonous color performance, uneven brightness, and waving/floating image of the conventional LED electronic billboard.

An input port 1421 and an output port 1422 are separately installed at two ends of the control circuit system 142. Via those ports and multiple concatenation flat cables 145, multiple LCD panels 141 arranged side by side can be concatenated to form a desired configuration of LCD billboard 14. Those LCD panels 141 can be interconnected horizontally and/or vertically, and the LCD billboard 14 shown in FIG. 4 is formed via horizontal interconnection.

Refer to from FIG. 5 to FIG. 8. As shown in FIG. 5, the driver elements 143 of the display unit 140 can be installed with an SMT (Surface Mount technology) process; those driver elements 143 are installed to the circuit board and control/drive the LCD panels 141 via multiple flat cables 144.

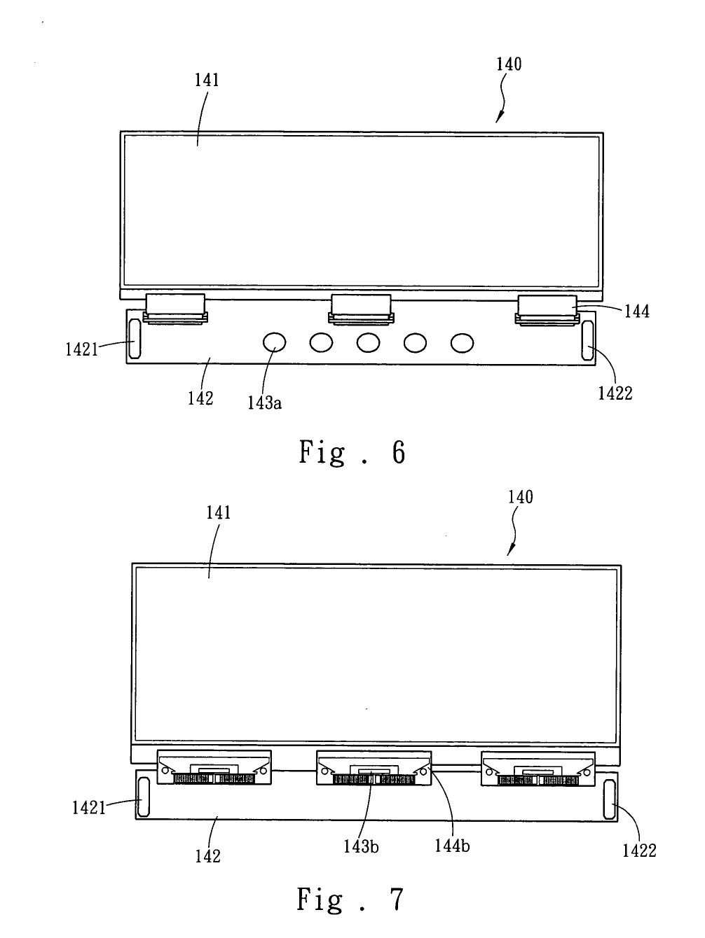

Otherwise, as shown in FIG. 6, the naked driver elements 143a are installed with a COB (Chip On Board) process; via the wire-bonding and flip-chip technologies, those driver elements 143a are installed to the circuit board and control/drive the LCD panel 141 via multiple flat cables 144.

Otherwise, as shown in FIG. 7, the driver elements 143b are installed with a TAB (Tape Automated Bonding) process, wherein the wiring pattern is formed on a long tape 144b to make a strip of leads, and those driver elements 143b are joined to those leads with bumps; those driver elements 143b control/drive the LCD panel 141 via the wiring on the tape 144b.

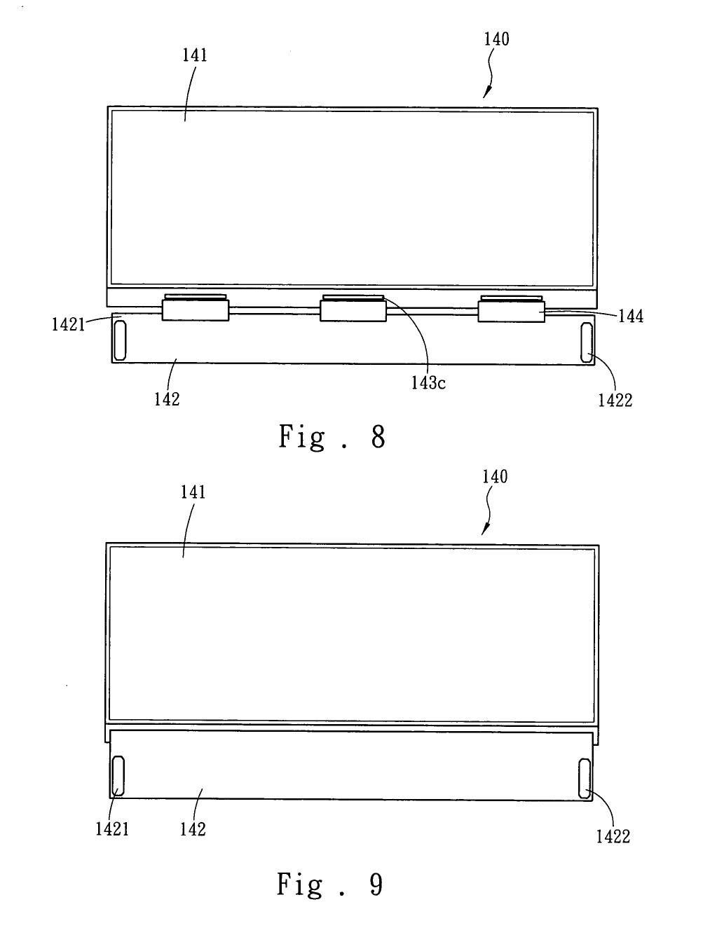

Otherwise, as shown in FIG. 8, the driver elements 143c are installed with a COG (Chip On Glass) process, wherein those driver elements 143c are directly joined to the glass substrate of the LCD display panel 141; those driver elements 143c are connected to the control circuit system 142 via multiple flat cables 144.

As shown in FIG. 9, the display unit 140 can also omit those flat cables 144, and the terminal sides of the LCD panel 141 can directly join with the terminals of the circuit board of the control circuit system 142, wherein the installation method of the driver elements 143 can be one of those mentioned above.

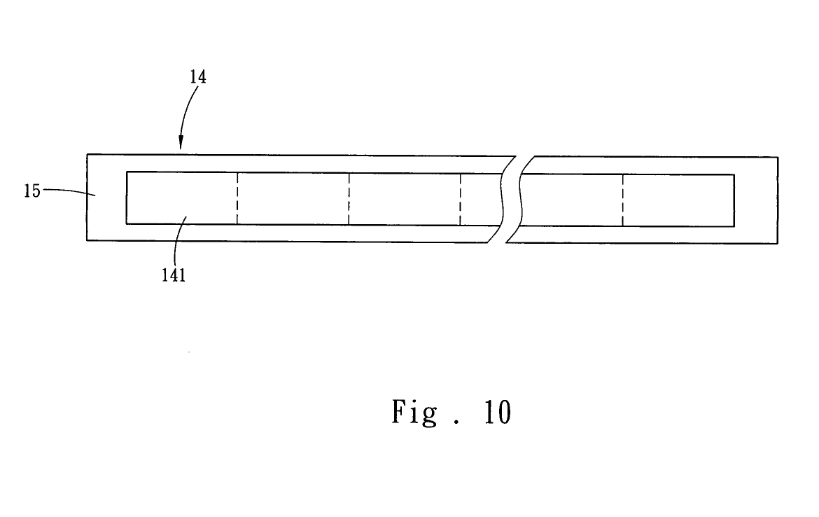

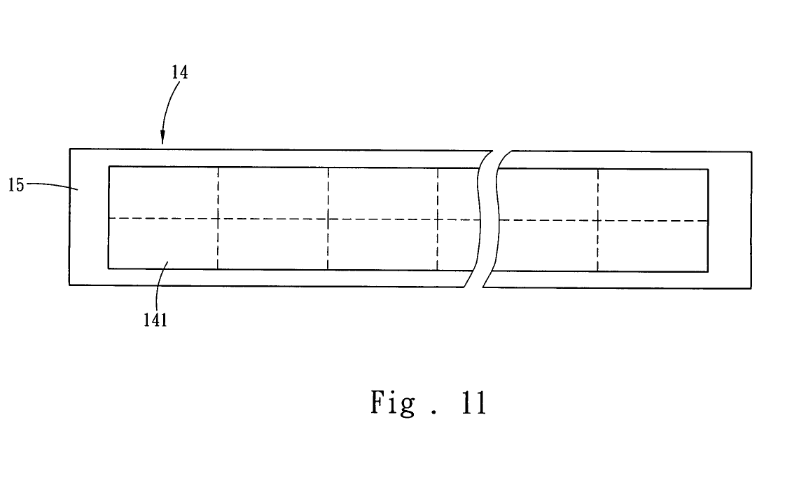

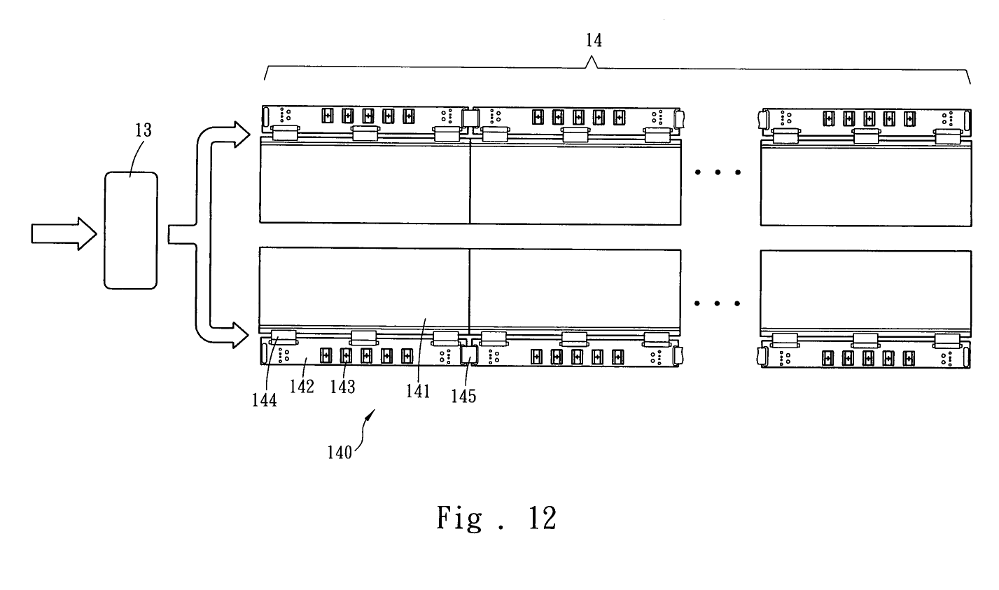

The applications of the present invention are to be described below. As shown in FIG. 10, a housing 15 is used to fix and protect the horizontally interconnected LCD panels 141, the control circuit systems 142 and the control systems 13; thereby, a single LCD billboard 14 is formed. The modularized display units 140, which are formed of the LCD panels 141 and the control circuit systems 142, can be assembled into various types of LCD billboards, such as a strip-like LCD billboard shown in FIG. 10. Those LCD panels 141 can also be assembled into a billboard with an arbitrary length-width ratio via horizontal and vertical interconnections. As shown in FIG. 1, the LCD panels 141 and the control circuit system 142 are interconnected horizontally and vertically. Refer to FIG. 12 a schematic diagram showing the structure of LCD billboard 14. Multiple LCD panels 141 are arranged horizontally and vertically, and multiple concatenation flat cables 145 are used to concatenate those LCD panels 141 section by section, and those sections respectively receive the data transmitted from the control system 13. Thereby, the assemblage of LCD billboard 14 can be diversified, and the fabrication cost can be reduced.

Those described above are only the preferred embodiments of the present invention but not intended to limit the scope of the present invention. Any equivalent modification and variation according to the spirit of the present invention is to be included within the scope of the present invention.

What is claimed is:

1. A liquid crystal information display, comprising:
a main-control system, having an operating software, and used to edit the information to be displayed and the display manner of the information;
a transmission interface, transmitting the edited information via the format of a standard transmission control protocol interface;
at least one liquid crystal display (LCD) billboard, displaying the information edited by said main-control system; and
at least one control system, receiving and storing the information transmitted from said transmission interface, and controlling the operation of said LCD billboard, and driving said LCD billboard to display the information.

2. The liquid crystal information display according to claim 1, wherein said main-control system can be selected from a personal computer, a notebook computer, a palm-size computer, a personal digital assistant, and a mobile phone.

3. The liquid crystal information display according to claim 1, wherein said transmission interface can be selected from a wired transmission control protocol interface and a wireless transmission control protocol interface.

4. The liquid crystal information display according to claim 1, wherein said control system further comprises:
a communication unit, receiving the data transmitted from said transmission interface;
a storage unit, storing the data received by said communication unit;
a central processing unit, processing the data stored in said storage unit;
an operation memory unit, temporarily storing the data processed by said central processing unit; and
a digital/analog converter unit, converting the digital data stored in said operation memory unit into the analog data needed by said LCD billboard.

5. The liquid crystal information display according to claim 1, wherein said LCD billboard further comprises at least one display unit, and said display unit further comprises a LCD panel and a control circuit system.

6. The liquid crystal information display according to claim 5, wherein said control circuit system further comprises multiple driver elements, and said driver elements control and drive said LCD panel via multiple flat cables.

7. The liquid crystal information display according to claim 5, wherein an input port and an output port are separately installed at two ends of said control circuit system, and via said ports and a concatenation flat cable, multiple said LCD panels arranged side by side can be concatenated to form a desired configuration of said LCD billboard.
